(19) United States
(12) Patent Application Publication
(10) Pub. No.: US 2006/0134279 A1
(43) Pub. Date: Jun. 22, 2006

(54) Light, tubular food casing having a transferable smoke flavor

(76) Inventors: Theresia Rieser, Eppelsheim (DE); Robert Wilfer, Versmold (DE); Hans-Gerd Ziemes, Krefeld (DE)

Correspondence Address: PROPAT, L.L.C., 425-C SOUTH SHARON AMITY ROAD, CHARLOTTE, NC, 28211-2841, US

(21) Appl. No.: 10/544,096

(22) PCT Filed: Feb. 7, 2004
(86) PCT No.: PCT/EP04/01135

§ 371 Date: Aug. 1, 2005

(30) Foreign Application Priority Data
Feb. 13, 2003 (DE) 103 06 223.8

(51) Int. Cl. A22C 13/00

(52) U.S. Cl. 426/135

(57) ABSTRACT

The invention relates to a tubular regenerated cellulose-based food casing which is impregnated with smoke aroma. The impregnation with a light smoke aroma reduces the L* value (determined in accordance with the CIE-LAB method) of the casing by no more than 5 and is then still at least 40. The L* value of the casing removed from the food has changed by no more than ±5. The casing is used as artificial sausage casing, in particular for raw sausage, preferably for salami, hard smoked sausage and dried sausage.

The invention relates to a regenerated cellulose-based tubular food casing which is impregnated with smoke aroma, and also to its use as artificial sausage casing.

Regenerated cellulose-based tubular food casings have long been used for producing sausage products. Use is made of casings of pure cellulose, and also those having an additional fiber paper reinforcement in the interior (what are termed fiber casings). In principle, there are currently two methods for producing cellulose or fiber casings. They differ essentially in the type of cellulose spinning solution used.

In the widespread viscose method, the cellulose, after prior preparation, is converted using sodium hydroxide solution and carbon disulfide into cellulose xanthogenate. The resultant viscose solution can be used for the extrusion of tubular cellulose or fiber casings. The cellulose xanthogenate, after the extrusion process, is regenerated back to cellulose under the action of sulfuric acid. Byproducts and acid residues are removed with the aid of wash baths. The manufacturing process is concluded by a drying stage in which excess water is removed from the gel tube.

Various upgrading steps can be connected intermediately or subsequently to the manufacturing process. For example, the casings can be finished with a plasticizer or the insides and/or outsides of the casings can be impregnated with additional components for controlling the adhesion to the sausage emulsion. In addition, a coating can be applied which acts as (additional) oxygen barrier and water vapor barrier, and the outside can be impregnated with a biocide. Some components which act to modify the properties of the casings can already be mixed directly with the viscose.

In addition, methods are also known in which the cellulose is brought directly into solution by the action of special solvents or complexing agents, without chemically derivatizing the cellulose. Such a method, which is also used for the production of sausage casings, is the NMMO method. The method is based on the solubility of cellulose in tertiary amine oxides, in particular in N-methylmorpholine N-oxide (NMMO). The additional upgrading steps customary in connection with the viscose method can be applied in a similar manner to the NMMO method.

Said production methods lead to pure cellulose casings or to fiber-reinforced cellulose casings which can then be impregnated with liquid smoke.

Smoking is carried out with raw sausages for reasons of hygiene. In addition, a smoked aroma and smoked taste of the sausage promote sales in many applications. The traditional smoking methods can be replaced by finishing the casing with liquid smoke.

To transfer smoke taste and aroma to sausage products, in addition to the methods of traditional smoking and smoking using liquid smoke, there is the possibility of impregnating sausage casings directly with liquid smoke. The sausage casings, then, during the ripening or cooking process, transfer the colorants, aroma substances and taste substances to the stuffing. In addition to the sensory upgrading of the sausage products, the smoke transfer in the case of raw sausage types serves particular hygiene purposes. Molds and unwanted bacteria are growth-inhibited or destroyed by fungicidally and bactericidally active smoke constituents.

The appearance of light, transparent, and very particularly white, cellulose-based sausage casings is changed greatly by liquid smoke. This applies to traditional smoking and also to the two liquid smoke methods. Light colors become darker. The previously known casings impregnated with liquid smoke frequently display unwanted dark, brown spots. The spots appear on the casing surface at the latest after the sausage ripening or cooking process. In the case of white sausage casings, this effect is particularly pronounced.

Generally, the brown discoloration of the emulsion surface is primarily based in all three methods on compounds which are capable of the Maillard reaction. In the case of (liquid) smoke, these are carbonyl compounds which react with the amino acids of the proteins in the sausage emulsion. It may be assumed that meat juice always to some extent impregnates the sausage casing, so that the reaction also takes place inside the casing and leads to unwanted discoloration particularly on the casing surface of light or white casings. In the case of raw sausage types which must be smoked for hygiene reasons, hitherto in the case of white sausage casings, an inhomogeneous discoloration of the surface had to be accepted.

A further cause of the brown discoloration is the intrinsic color of the primary and secondary pyrolysis products formed in smoke production.

In the case of sausage casings impregnated with liquid smoke, the discoloration is particularly strongly pronounced. Liquid smoke is obtained by the controlled pyrolysis of wood material and subsequent condensation of smoke constituents using water. In further production steps, the condensed smoke is purified and, if required, concentrated. The process of liquid smoke production has already been described in a multiplicity of patents. Conventional liquid smoke has a deep dark brown to black intrinsic color.

In the prior art, numerous methods for producing sausage casings impregnated with liquid smoke are described. The liquid smoke acts here both as coloring and flavoring substance for sausage products (U.S. Pat. Nos. 4,604,309, 4,442,868 and 4,446,167). Frequently in the patents, the use of basic liquid smoke is described, to which significantly stronger coloring is ascribed than to acidic liquid smoke (U.S. Pat. No. 6,032,701).

The object was therefore to provide a light, in particular white, cellulose-based food casing which can transfer the smoked aroma and smoked flavor to a food situated therein, which does not become significantly darker as a result of the smoke constituents, and in particular does not appear spotty, and even after ripening or storage, the sausage does not become spotty.

The object is achieved by a special liquid smoke in which the flavor and aroma components predominate over the coloring components. The casing is therefore, after the treatment with the liquid smoke, not significantly darker (expressed by the L* value) and the L* value of the casing changes only little when it is removed from the food to which the smoked aroma and flavor have been transferred.

The present invention therefore relates to a regenerated cellulose-based tubular food casing which is impregnated with smoke aroma, wherein the L* value, determined by the CIE-LAB method, of the casing has decreased due to the impregnation by no more than 5 and before stuffing is still at least 40, and the L* value of the casing removed from the food is changed by no more than ±5. Preferably, the L* value of the casing after the impregnation and before stuffing has decreased by 0.1 to 2.

After the ripening time, the casings are removed and their lightness and color values are determined. Preferably, the L* value of the casing, after removal from the food, has decreased only by 0.1 to 3. The change in the a* and b* values is then generally no more than ±3, preferably no more than ±2. The measure used for determining these values is casings which are stuffed with raw sausage emulsion as defined in the examples, and are ripened as described.

In a preferred embodiment, the inventive casing is a white, cream-colored or chamois-colored casing having an L* value of more than 80, preferably more than 90.

Use is made of a liquid smoke (smoke aroma) which in itself has only a weakly brown to yellow intrinsic color, and in which flavor components dominate. In the case of raw sausage varieties, the color transfer is less important than the flavor transfer. The weakly colored smoke aromas effect sufficient flavor transfer even at low concentrations. This avoids white or light casings being discolored in an unwanted manner. The casings treated with the smoke aroma therefore generally have a lightness value L* of more than 40 (determined by the CIE-LAB method, DIN 6174, using light type D65, 10 normal observer).

Surprisingly, a relatively low amount of smoke aroma is sufficient to transfer a significant smoke flavor and a distinct smoke aroma to the food. The amount, at the same time, is so low that, despite the intrinsic color of the smoke aroma, no discoloration of the casing occurs.

Expediently, the inside of the casing is impregnated with the smoke aroma. The smoke aroma differs from the conventional liquid smoke in that the flavor components dominate compared with the coloring components. By means of these special smoke aromas, even light-colored and, especially, white tubular cellulose-based food casings can be produced, which can transfer smoke aroma to the sausage emulsion, without unwanted casing discoloration occurring. The inside of the casing can additionally be finished with components, for example with substances which affect the properties of the casing, such as peelability or suppleness.

The inventive casing is particularly suitable for producing raw sausage types, but also for scalded-emulsion sausage and ham. The food casings can be present in a wide variety of finished types, e.g. rolls, sections and shirred sticks. The casings, as required, are soaked in water before the stuffing process, or they are actually processed as premoistened product ready for stuffing.

A number of possibilities exist for producing such weakly colored smoke aromas for the transfer of odor and flavor. Suitable possibilities are, for example, natural smoke aromas which are obtained by condensation in water of smoke constituents as are formed in the pyrolysis of hard woods. The liquid smoke is purified and worked up. Subsequent concentration of the flavoring components or admixture of a flavor concentrate to the liquid smoke is also conceivable. Furthermore, use can be made of flavor concentrates which can be produced from natural liquid smoke, for example by extraction. In principle, all types of natural, nature-identical and artificial aromas are suitable as raw material base, which lead to a transfer of smoke flavor to the sausage emulsion without causing casing discoloration. Suitable liquid-smoke-based smoke aromas are offered by the companies W. Ruitenberg Czn N.V. and Red Arrow International LLC, for example under the names RA 99044 and Zesti Smoke Code 425. These smoke aromas have not hitherto been used for impregnating food casings. They have instead been mixed directly with the food, especially the sausage emulsion, or applied directly to the meat product.

For the present invention, it is of no importance in which manner the starting material was produced. It can therefore be produced by the viscose method, by the likewise above-described NMMO method, or any other method.

The inventive casing may be produced by various methods. For instance, the casing can be passed through an impregnation vat containing liquid smoke. The application here naturally takes place from the outside. Instead, or in addition, there is the possibility of also impregnating the inner surface of the casings with liquid smoke. Liquid smoke can also be applied during shirring of the casing. In that case, the shirring mandrel is expediently combined with a spraying apparatus. Liquid smoke can in principle be applied to the gel skin (the casing before the drying process is termed the gel skin) or onto the previously dried skin. A suitable method is described, for example, in U.S. Pat. No. 4,518,619.

The peeling properties of the inventive sausage casing may be controlled by means of additional components. Essentially there are three different methods for finishing a cellulose-based food casing with what are termed peeling or adhesion components. The casing can first be charged on the inner casing surface e.g. with a peeling component, and then it is treated with liquid smoke. In practice, ketene dimers or chromium fatty acid complexes usually act as peeling components.

Likewise, in a first step, the outside of the casing can be charged with liquid smoke, before, in a second step, a peeling component is applied to the inside. This second step can be performed in this case before or during the shirring.

Peeling or adhesion components can also be added directly to the liquid smoke when the liquid smoke is applied via an inner impregnation of the casing.

The casings impregnated with the light liquid smoke can be finally processed in the customary manner. They can therefore be present not only as rolls, but also in the form of sections tied off at one end or in the form of shirred sticks.

The inventive food casings can be used for producing scalded-emulsion sausage (e.g. ham sausage), small scalded-emulsion sausages (e.g. frankfurters) and also cooked or raw cured-meat products (e.g. cooked ham, cured smoked pork loin). Their advantages apply particularly in the production of raw sausage, for example hard smoked sausages, salami and dried sausages.

The aroma raw materials are applied by one of the known methods for internal impregnation to the inside of the light to white cellulose casing or fibrous casing. The internal impregnations, depending on the adhesion properties of the casings, can also comprise other components. In the case of casings which are to exhibit particularly strong adhesion to the emulsion, preferably proteins or cationic resin components are also additionally admixed. In the case of casings of low emulsion adhesion, the internal impregnation solutions can comprise mixtures of proteins or cationic resin components having adhesion-decreased components. As adhesion-decreasing active compounds, use is preferably made of ketene dimers and/or chromium-fatty acid complexes. For casings of very low emulsion adhesion, use can be made of cellulose ether derivatives, e.g. carboxymethylcellulose, ketene dimers and chromium-fatty acid complexes.

In addition, occasionally further aids are added to the internal impregnation, e.g. plasticizers, natural or synthetic oils. In the case of white sausage casings, discoloration of the casing surface by meat juice which exits from the sausage emulsion during ripening and is absorbed by the casing can even be critical. Various measures are cited in the literature to prevent such discolorations, e.g. preparing the casing interior with glucono-δ-lactone.

In the case of the present invention, standard adhesion or peeling impregnations are added to the smoke aroma at a concentration of 0.5 to 20% by weight, based on the total mass of the solution. Preferably, the concentration of the smoke aroma in the impregnation solution is 0.5 to 10% by weight.

After the internal impregnation of the casings, the artificial skin is dried and finally processed by customary standard methods. For the stuffing process, the casings can, as required, be briefly soaked in water, or they are already finally processed ready for stuffing.

The examples hereinafter serve to illustrate the invention. Percentages therein are percentages by weight, unless stated otherwise or obvious from the context.

### EXAMPLES 1 TO 8

In all examples, a double-viscosed, white cellulose fibrous casing (viscose distribution: 50% interior, 50% exterior) of a caliber of 80 mm and a weight per square meter of 115 g/m² and also a paperweight of 19 g/m² was used. The casing was impregnated internally with 400 mg/m² of glucono-δ-lactone. In addition, an adhesion impregnation based on polyamidoamine-epichlorohydrin resin (also termed polyaminopolyamide-epichlorohydrin resin) was applied to the inside (150 mg/m²).

In examples 3 to 8, the light smoke aroma specially selected for the present invention to a standard adhesion impregnation for white fibrous casings was added and then the inside of the fibrous skin was impregnated with this mixture, whereas in example 2 the inside was impregnated with a conventional dark smoke solution.

TABLE 1

| | | Content)* in |
|---|---|---|
| Examples | Smoke aroma | % by weight |
| 1 | No smoke aroma | |
| 2 | Liquid smoke from the smoke of | |
| | hardwoods, pH of the solution 2.6 | |
| 3 | ®Zesti Smoke Code 425 W | 1 |
| | (W. Ruitenberg Czn N.V.) | |
| 4 | ®Zesti Smoke Code 425 | 3 |
| 5 | ®Zesti Smoke Code 425 | 7 |
| 6 | RA 99044 (Red Arrow International LLC) | 1 |
| 7 | RA 99044 | 3 |
| 8 | RA 99044 | 7 |

)*Content of the smoke aroma in the impregnation solution

The effect of the aromas on the casing color was studied with the aid of the CIE-LAB method. Color and lightness of the casing were characterized with the aid of the LAB values. The values were determined using a LUCI 100 spectrometer from Dr. Lange. The L* value describes the lightness of the casing. The value 100 corresponds to the highest lightness, that is to say the ideal white; L*=0 denotes black. The red fraction is denoted by +a*, the green fraction by −a*. The +b* value describes the yellow fraction, and the −b* value the blue fraction.

The casings were analyzed directly after production (1) then again after the raw sausage ripening (2). The stuffed samples were peeled and the LAB values of the outside were then determined. Casings which had been produced without aroma substances or with conventional liquid smoke (see table 2) served as controls. A sausage having a casing according to example 1 was subjected to smoking for preservation. The LAB values of the casings containing aroma substances are shown in table 3. Table 4 verifies the negligible effect of the aroma substances on the lightness and color. The differences between the LAB values of the unstuffed casing according to examples 1 to 8 and the LAB value of the unstuffed casing according to example 1 (values designated 1 in table 2) as standard confirm this very clearly. The difference was formed according to equations 1 to 3. Table 5 shows the ΔLAB values as a measure of the change in lightness of the casings and casing color caused by finishing the casings with liquid smoke, smoke aroma, smoking and the ripening process. For this, the LAB value of the unstuffed casings according to example x was used as reference value (values denoted ¹⁾ in tables 2 and 3) and the differences were formed with the LAB values of the respective stuffed casings x (values denoted ²⁾ in tables 2 and 3). The ΔLAB values are listed in table 5. The difference was formed in accordance with equations 4 to 6.
ΔL*=¹⁾L*(sample x)−¹⁾L*(sample 1) 1.
Δa*=¹⁾a*(sample x)−¹⁾a*(sample 1) 2.
Δb*=¹⁾b*(sample x)−¹⁾b*(sample 1) 3.
ΔL*=²⁾L*(sample x)−¹⁾L*(sample x) 4.
Δa*=²⁾a*(sample x)−¹⁾a*(sample x) 5.
Δb*=²⁾b*(sample x)−¹⁾b*(sample x) 6.

“Sample x” denotes the casing according to comparative example 2 or one of the examples 3 to 8, “sample 1” according to comparative example 1.

The ΔLAB values in table 4 verify the low differences in lightness and color before and after the aroma preparation of an unstuffed light-colored casing. A decrease in lightness was in the range ΔL*=−0.1 to −5, preferably in the −0.1 to −2 range. A change of the Δa* was in the interval from −5 to +5, preferably from −1 to +1. A change of the Δb* was in the interval from −5 to +5, preferably from −1.5 to +1.5. However, preparation using conventional liquid smoke had a very distinct effect on color and lightness of the casing: the decrease in lightness was −9.68, the color range of the casing increased particularly in the yellow fraction. Smoking the sausage having a casing according to example 1 likewise resulted in a great decrease in lightness with simultaneous increase in the yellow and red fraction (table 2).

TABLE 2
LAB values of the casings according
to comparative examples 1 and 2

| | ¹⁾L* | ¹⁾a* | ¹⁾b* | ²⁾L* | ²⁾A* | ²⁾b* |
|---|---|---|---|---|---|---|
| Example | value | value | value | value | value | value |
| 1 | 94.86 | 0.08 | 4.42 | 82.38 | 2.86 | 12.58 |
| 2 | 85.18 | 2.56 | 12.53 | 86.91 | 1.32 | 9.79 |

¹⁾before stuffing,
²⁾after the ripening process

TABLE 3
LAB values of the examples having smoke aroma

| | ¹⁾L* | ¹⁾a* | ¹⁾b* | ²⁾L* | ²⁾a* | ²⁾b* |
|---|---|---|---|---|---|---|
| Example | value | value | value | value | value | value |
| 3 | 93.54 | 0.55 | 5.25 | 92.00 | 0.34 | 5.72 |
| 4 | 93.44 | 0.62 | 5.45 | 92.14 | 0.40 | 5.72 |
| 5 | 93.46 | 0.59 | 5.32 | 92.01 | 0.40 | 5.36 |
| 6 | 92.96 | 0.66 | 5.55 | 91.97 | 0.81 | 6.30 |
| 7 | 92.98 | 0.63 | 5.56 | 91.92 | 0.43 | 5.83 |
| 8 | 93.00 | 0.57 | 5.50 | 92.10 | 0.45 | 5.78 |

¹⁾before stuffing,
²⁾after the ripening process

TABLE 4
ΔLAB values as a measure of the effect of the aroma
preparation compared with conventional liquid smoke

| Example | ΔL* value | Δa* value | Δb* value |
|---|---|---|---|
| 2 | −9.68 | 2.48 | 8.11 |
| 3 | −1.32 | 0.47 | 0.83 |
| 4 | −1.42 | 0.54 | 1.03 |
| 5 | −1.40 | 0.51 | 0.9 |
| 6 | −1.90 | 0.58 | 1.13 |
| 7 | −1.88 | 0.55 | 1.14 |
| 8 | −1.86 | 0.49 | 1.08 |

The ΔLAB values in table 5 show that the casings produced using smoke aroma, after ripening, show only very small changes with respect to color and lightness. The change in lightness was in the range ΔL*=±5, preferably in the range ΔL*=−0.1 to −3. Δa* and Δb* were in the interval −3 to +3, preferably −2 to +2. Although the casing which was treated with conventional liquid smoke according to comparative example 2 also showed, after ripening, only small changes in color and lightness, its absolute LAB values were already markedly poorer before stuffing. For instance, the L* value of the unstuffed casing according to comparative example 2 was 85.18 compared with 94.86 for an unstuffed white casing without liquid smoke.

TABLE 5
ΔLAB values as index of the effect of smoke aroma, smoking
and conventional liquid smoke after raw sausage ripening

| Example No. | ΔL* value | Δa* value | Δb* value |
|---|---|---|---|
| 1 | −12.48 | 2.78 | 8.16 |
| 2 | −1.73 | −1.24 | −2.74 |
| 3 | −1.54 | −0.21 | 0.47 |
| 4 | −1.30 | −0.22 | 0.27 |
| 5 | −1.45 | −0.19 | 0.04 |
| 6 | −0.99 | −0.15 | 0.74 |
| 7 | −1.06 | −0.20 | 0.27 |
| 8 | −0.90 | −0.12 | 0.28 |

With the aid of stuffing tests, in addition to an optical evaluation, a taste evaluation was also carried out. For this, in both cases a rating of 1 to 6 was awarded. For the stuffing tests according to examples 1 to 8, the casings were stuffed with standard raw sausage (salami), ham and scalded-emulsion sausage emulsion. Rating scale for the taste and optical evaluation of the stuffing tests:

1 = very good
2 = good
3 = satisfactory
4 = adequate
5 = unsatisfactory
6 = poor

The transfer of the smoke flavor from the casing to the emulsion was of importance in this case. In the range from 0.5 to 20% by weight of smoke aroma, based on the total mass of the impregnation solutions, a graded smoke transfer was produced. In particular in the range from 3 to 10% by weight of smoke aroma, the emulsion flavor was advantageously expressed.

Stuffing Tests

Smoking:

The casing according to comparative example 1 was, after stuffing with raw sausage emulsion, subjected to a cold smoking for 24 h at 28° C. and at a relative humidity of 75%.

Raw Sausage Production (Standard Raw Sausage):

Use was made of an emulsion of 70% meat (from the shoulder of the pig) and 30% fat (back fat of the pig) which were stored at −30° C., and also 24 g/kg of nitrite curing salt. The water activity (a_{w} value) was 0.98 to 0.99. The pH was 6.0 (measured 24 h after slaughter). The constituents were comminuted at −5 to 0° C. (pH up to 5.9; a_{w} value 0.96 to 0.97). The casing was stuffed at a temperature of −3 to 1° C. Ripening was performed after an equilibration time of about 6 hours at a room temperature of 20 to 25° C. and a relative atmospheric humidity below 60% in three sections in a dark room.

| Ripening | | Section I | Section II | Section III |
|---|---|---|---|---|
| Room | Temperature | 18 to 25° C. | 18 to 22° C. | around 15° C. |
| | Rel. atom. humidity | 90 to 92% | 85 to 90% | 75 to 80% |
| | Air speed | 0.5 to 0.8 m/sec | 0.2 to 0.5 m/sec | 0.05 to 0.1 m/sec |
| Product | pH | 5.2 to 5.6 | 4.8 to 5.2 | 5.0 to 5.6 |
| | a_{w} value | 0.94 to 0.96 | 0.90 to 0.94 | 0.85 to 0.92 |
| | Ripening time | 3 days | 7 days | 6 weeks |

The end product in the present case, after ripening for 6 weeks, had a pH of 5.3, and the water activity (a_{w}) was 0.87%

Scalded-Emulsion Sausage Production (Meat Sausage):

For the meat sausage production, the stuffed skin was heated at 75° C. for 90 min.

Ham Production (Boiled Ham from Reformed Ham):

For ham production, the stuffed casing was heated at 75° C. for 90 min.

Tables 6 to 8 show the stuffing test results achieved using the casings according to the comparative examples 1 and 2 and the inventive examples 3 to 8.

TABLE 6
Tests using raw sausage emulsion
Scores for optical appearance (x)/flavor transfer (∘)

| Example | 1 | 2 | 3 | 4 | 5 | 6 |
|---|---|---|---|---|---|---|
| 1 | ∘ | | | | x | |
| 2* | | | | | | x |
| 3 | x | | ∘ | | | |
| 4 | x | ∘ | | | | |
| 5 | x/∘ | | | | | |
| 6 | x | | ∘ | | | |
| 7 | x | ∘ | | | | |
| 8 | x/∘ | | | | | |

*Example 2 was only evaluated optically

TABLE 7
Tests with scalded-emulsion sausage emulsion
Scores for optical appearance (x)/flavor transfer (∘)

| Example | 1 | 2 | 3 | 4 | 5 | 6 |
|---|---|---|---|---|---|---|
| 2* | | | | | | x |
| 3 | x | | ∘ | | | |
| 4 | x | ∘ | | | | |
| 5 | x/∘ | | | | | |
| 6 | x | | ∘ | | | |
| 7 | x | ∘ | | | | |
| 8 | x/∘ | | | | | |

*Example 2 was only evaluated optically

TABLE 8
Tests with ham emulsion
Scores for optical appearance (x)/flavor transfer (∘)

| Example | 1 | 2 | 3 | 4 | 5 | 6 |
|---|---|---|---|---|---|---|
| 2* | | | | | | x |
| 3 | | | ∘ | | | |
| 4 | x | ∘ | | | | |
| 5 | x | ∘ | | | | |
| 6 | x | | ∘ | | | |
| 7 | x | ∘ | | | | |
| 8 | x | ∘ | | | | |

*Example 2 was only evaluated optically

1. A regenerated cellulose-based tubular food casing comprising impregnated smoke aroma, wherein the L* value, determined by the CIE-LAB method, of the casing has decreased due to the impregnated smoke aroma by no more than 5 and before stuffing is still at least 40, and the L* value of the casing removed from food situated therein is changed by no more than ±5.

2. The food casing as claimed in claim 1, wherein its L* value after the impregnation and before stuffing has decreased by 0.1 to 2.

3. The food casing as claimed in claim 1, wherein its L* value, after removal from the food, has decreased by 0.1 to 3.

4. The food casing as claimed in claim 1, wherein the change of the a* value due to the impregnation is, before stuffing, not more than ±5.

5. The food casing as claimed in claim 1, wherein the change of the b* value due to the impregnation is, before stuffing, no more than ±5.

6. The food casing as claimed in claim 1, wherein the change of the a* and b* value, after removal from the food, is no more than ±3.

7. The food casing as claimed in claim 1, wherein it has a fibrous reinforcement.

8. The food casing as claimed in claim 1, wherein the fibrous reinforcement is a fibrous paper.

9. The food casing as claimed in claim 1, wherein it is a white, cream-colored or chamois-colored casing having an L* value of more than 80.

10. The food casing as claimed in claim 1, wherein, on the inside, it additionally has an adhesion preparation.

11. The food casing as claimed in claim 1, wherein, on the inside, it additionally has a release preparation.

12. The food casing as claimed in claim 1, wherein it is finally processed.

13. A method for producing a food casing as claimed in claim 1, said method comprising applying to the inside of a tubular cellulose-based food casing an impregnation liquid which comprises a smoke aroma having a weakly brown to yellow intrinsic color.

14. An artificial sausage casing comprising a food casing as claimed in claim 1.

15. An artificial sausage casing as claimed in claim 14, wherein the casing is a salami casing, a hard smoked sausage casing or a dried sausage casing.

16. A food casing as claimed in claim 12, wherein the food casing is in the form of a shirred stick or in the form of sections tied off at one end.
